(19) United States
(12) Patent Application Publication
(10) Pub. No.: US 2025/0349921 A1
(43) Pub. Date: Nov. 13, 2025

(54) ABNORMALITY DETERMINATION SYSTEM AND ABNORMALITY DETERMINATION METHOD

(71) Applicant: TOYOTA JIDOSHA KABUSHIKI KAISHA, Toyota-shi (JP)

(72) Inventor: Natsuki TANAKA, Nagoya-shi (JP)

(73) Assignee: TOYOTA JIDOSHA KABUSHIKI KAISHA, Toyota-shi (JP)

(21) Appl. No.: 19/096,065

(22) Filed: Mar. 31, 2025

(30) Foreign Application Priority Data
May 9, 2024 (JP) 2024-076279

(51) Int. Cl. H01M 10/48; H01M 10/613; H01M 10/625; H01M 10/63; H01M 10/6563

(52) U.S. Cl. CPC H01M 10/486; H01M 10/63; H01M 10/6563; H01M 10/613; H01M 10/625; H01M 2220/20

(57) ABSTRACT

The abnormality determination system is a system for determining an abnormality of a battery, and includes a battery, a cooling fan for cooling the battery, a submergence sensor for detecting submergence of water in a part where the cooling fan is provided, and an ECU for controlling the cooling fan. ECU performs control to operate the cooling fan after the submergence of water is detected by the submergence sensor and after a predetermined condition for determining an abnormality of the cooling fan is satisfied, and determines that the cooling is abnormal when a specific condition indicating that the cooling fan is not functioning normally is satisfied.

### CROSS-REFERENCE TO RELATED APPLICATION

This application claims priority to Japanese Patent Application No. 2024-076279 filed on May 9, 2024, incorporated herein by reference in its entirety.

### BACKGROUND

### 1. Technical Field

The present disclosure relates to an abnormality determination system and an abnormality determination method, and more particularly, to an abnormality determination system for determining an abnormality of a battery and an abnormality determination method for determining an abnormality of a battery device.

### 2. Description of Related Art

Hitherto, there is a vehicle that includes a battery and a cooling device for cooling the battery, and that operates the cooling device to cool heat of the battery (see, for example, Japanese Unexamined Patent Application Publication No. 2015-049999 (JP 2015-049999 A)).

### SUMMARY

In the vehicle as in JP 2015-049999 A, the cooling device is not operated unless the temperature of the battery rises. When the air temperature is low as in winter, the temperature of the battery does not rise, and thus the cooling device cannot be operated. For example, even if the cooling device has failed due to submergence of the vehicle at an initial timing of a period in which the air temperature is low, the cooling device is not operated for a long period of time because the temperature of the battery does not rise. Therefore, the abnormality of the cooling device is not detected for a long period of time. Since it is difficult to identify the timing and cause of the occurrence of the abnormality of the cooling device, there is room for improvement in the guarantee of the cooling device.

The present disclosure provides an abnormality determination system and an abnormality determination method capable of appropriately determining an abnormality of a cooling device.

An abnormality determination system according to the present disclosure is a system configured to determine an abnormality of a battery. The abnormality determination system includes:

the battery;
a cooling device configured to cool the battery;
a sensor configured to detect submergence of a portion provided with the cooling device; and
a processor configured to control the cooling device.
The processor is configured to:
control the cooling device to operate after the submergence is detected by the sensor and after a predetermined condition for determination on an abnormality of the cooling device is satisfied; and
determine that cooling is abnormal when a specific condition indicating that the cooling device is not functioning normally is satisfied.

In such a configuration, the cooling device is operated after the submergence of the portion provided with the cooling device that cools the battery is detected and after the condition for determination on the abnormality of the cooling device is satisfied. When the condition indicating that the cooling device is not functioning normally is satisfied, determination is made that the cooling is abnormal. As a result, it is possible to provide the abnormality determination system capable of appropriately determining the abnormality of the cooling device.

The predetermined condition may be a condition that the submergence is not detected by the sensor, or a condition that a predetermined period has elapsed after the submergence is detected by the sensor.

With such a configuration, it is possible to determine the abnormality of the cooling device at an appropriate timing.

The specific condition may be a condition that a temperature of the battery does not decrease after the cooling device is operated as compared to a timing before the cooling device is operated, or a condition that a rotation speed of a fan of the cooling device decreases as compared to a normal rotation speed.

With such a configuration, it is possible to determine the abnormality of the cooling device based on an appropriate criterion.

The processor may be configured to control the cooling device to operate when the predetermined condition is not satisfied after the submergence is detected by the sensor, and a temperature of the battery exceeds a predetermined temperature.

With such a configuration, even when the condition for determination on the abnormality of the cooling device is not satisfied, the cooling device can be operated as long as the cooling device can be operated when the temperature of the battery rises.

According to another aspect of the present disclosure, an abnormality determination method is a method for determining an abnormality of a battery device.

The battery device includes:
a battery;
a cooling device configured to cool the battery;
a sensor configured to detect submergence of a portion provided with the battery and the cooling device; and
a processor configured to control the cooling device.
The abnormality determination method includes causing the processor to:
control the cooling device to operate after the submergence is detected by the sensor and after a predetermined condition for determination on an abnormality of the cooling device is satisfied; and
determine that cooling is abnormal when a specific condition indicating that the cooling device is not functioning normally is satisfied.

With such a configuration, it is possible to provide the abnormality determination method capable of appropriately determining the abnormality of the cooling device.

According to the present disclosure, it is possible to provide the abnormality determination system and the abnormality determination method capable of appropriately determining the abnormality of the cooling device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle according to this embodiment; and

FIG. 2 is a flowchart illustrating a flow of the cooling abnormality detection process according to the present embodiment.

### DETAILED DESCRIPTION OF EMBODIMENTS

Hereinafter, embodiments of the present disclosure will be described in detail with reference to the drawings. It should be noted that the same or corresponding portions in the drawings are designated by the same reference signs and repetitive description will be omitted.

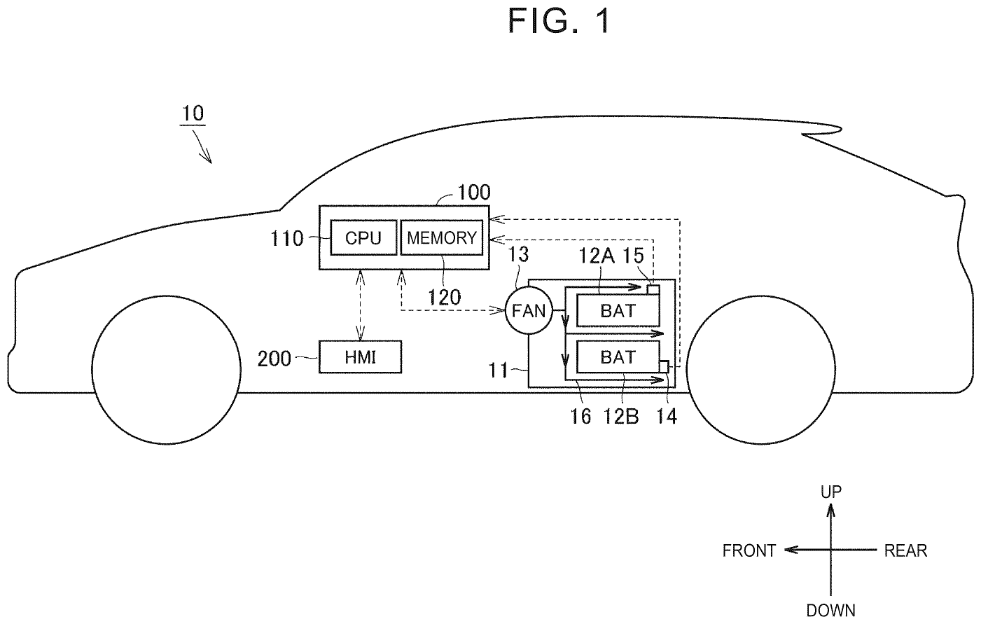

FIG. 1 is a schematic configuration diagram of a vehicle 10 according to this embodiment. The vehicles 10 are, for example, battery electric vehicle (hereinafter referred to as “BEV (Battery Electric Vehicle)”). The vehicle 10 includes an electronic control unit (hereinafter referred to as “ECU (Electronic Control Unit)”) 100, a battery unit 11, and an HMI (Human Machine Interface) 200.

ECU 100 includes a CPU 110 and memories 120. The memories 120 include RAM (Random Access Memory) and ROM (Read Only Memory) and store programs and data used in CPU 110. CPU 110 executes a predetermined process defined by the program according to the program and the data stored in the memory 120 and the data inputted from the outside, and stores the data of the executed result in the memory 120 or outputs the data to the outside.

The battery unit 11 includes a battery 12A, 12B, a cooling fan 13, a submergence sensor 14, and a temperature sensor 15.

The battery 12A, 12B is constituted by, for example, a lithium-ion battery, and stores electric power used for traveling of the vehicles 10. However, the battery 12A, 12B is not limited thereto, and may be formed of other types of batteries, for example, a nickel metal hydride battery or an all-solid-state battery.

The cooling fan 13 is a device that cools the battery 12A, 12B by sucking outside air by a fan driven by power by an electric motor and sending the sucked outside air to the periphery of the battery 12A, 12B along the flow path 16.

The submergence sensor 14 is a sensor that detects water that has entered the battery unit 11. The submergence sensor 14 is provided in a housing of the battery unit 11 in which the cooling fan 13 is provided. The submergence sensor 14 has two detection terminals, and when water enters between the detection terminals, a current flows between the detection terminals, and when the water does not enter, no current flows between the detection terminals (see, for example, Japanese Unexamined Patent Application Publication No. 2023-176081 (JP 2023-176081 A)). The submergence sensor 14 provides an ECU 100 with an indication of the magnitude of the current between the two sensing terminals.

The temperature sensor 15 is a sensor for detecting the temperature of the battery 12A, 12B, and is provided in the flow path 16 through which the outside air from the cooling fan 13 flows, and outputs a signal indicating the detected temperature to ECU 100.

HMI 200 is provided in the vicinity of the driver's seat of the vehicle 10. HMI 200 receives information inputted from the user and outputs the received information to ECU 100, or displays or audibly notifies the user of the information from ECU 100. HMI 200 includes, for example, a touch panel display.

In the above-described vehicles 10, the cooling fans 13 are operated to cool the heat of the battery 12A, 12B. Therefore, the cooling fan 13 is not operated unless the temperature of the battery 12A, 12B rises. When the temperature is low, such as in winter, the temperature of the battery 12A, 12B does not increase, and thus the cooling fan 13 is not operated. For this reason, for example, even when the cooling fan 13 fails due to submergence of the vehicles 10 at the first time of the period in which the air temperature is low, the period in which the cooling fan 13 is not operated for a long time because the temperature of the battery 12A, 12B does not increase continues. Therefore, the abnormality of the cooling fan 13 is not detected for a long period of time. As a result, it is difficult to identify the timing and the cause of the occurrence of the abnormality in the cooling fan 13, and there is a concern that a trouble related to the guarantee of the cooling fan 13 may occur.

Therefore, ECU 100 performs control so as to operate the cooling fan 13 after the submergence is detected by the submergence sensor 14 and after the predetermined condition for determining the abnormality of the cooling fan 13 is satisfied. ECU 100 determines that the cooling is abnormal when a specific condition indicating that the cooling fan 13 is not functioning normally is satisfied.

Thus, after the water immersion of the part where the cooling fan 13 for cooling the battery 12A, 12B is provided is detected, and after the condition for determining the abnormality of the cooling fan 13 is satisfied, the cooling fan 13 is activated, and when the condition indicating that the cooling fan 13 is not functioning normally is satisfied, it is determined that the cooling abnormality is present. As a result, the abnormality of the cooling fan 13 can be appropriately determined.

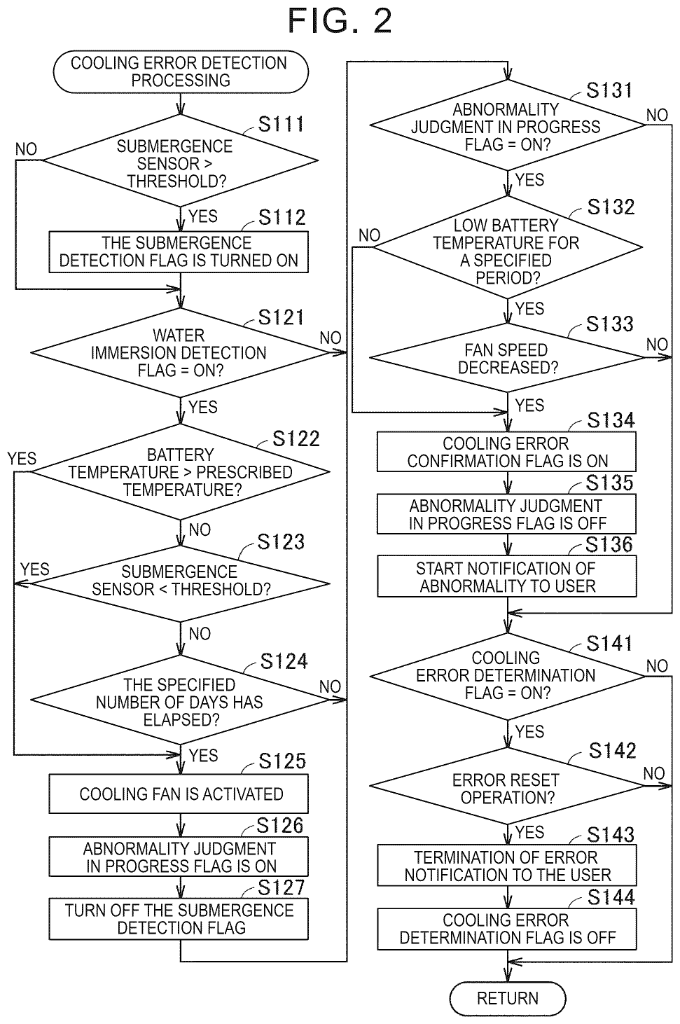

FIG. 2 is a flowchart illustrating a flow of the cooling abnormality detection process according to the present embodiment. Referring to FIG. 2, this cooling-abnormality detection process is called from a higher-level process at every predetermined cycle by CPU 110 of ECU 100 and is executed.

CPU 110 of ECU 100 determines whether or not the magnitude of the current indicated by the signal received from the submergence sensor 14 exceeds a threshold (S111). The threshold value is a value smaller than a value indicating the magnitude of the current output from the submergence sensor 14 when the water is submerged, and a value larger than a value indicating the magnitude of the current output from the submergence sensor 14 when the water is not submerged. That is, when the threshold value is exceeded, it can be determined that the submergence is detected by the submergence sensor 14. If it is determined that the threshold is exceeded (YES in S111), CPU 110 switches the submergence detection flag indicating that the battery 12A, 12B is submerged (S112).

On the other hand, if it is determined that the thresholds are not exceeded (NO in S111), or after S112, CPU 110 determines whether or not the water immersion detection flag is in the on-state (S121). If it is determined that the battery is in the on-state (YES in S121), CPU 110 determines whether the temperature of the battery 12A, 12B indicated by the signal from the temperature sensor 15 exceeds a predetermined temperature (S122). When the battery 12A, 12B exceeds a predetermined temperature, it is recommended to cool the battery in order to achieve rated performance.

If it is determined that the temperature of the battery 12A, 12B does not exceed the predetermined temperature (NO in S122), CPU 110 determines whether or not the magnitude of the current indicated by the signal received from the submergence sensor 14 is below the aforementioned threshold (S123). If it falls below the threshold value, it can be determined that the submergence sensor 14 has no longer detected the submergence. If it is determined that the threshold is not lower than the threshold (NO in S123), it is determined whether or not a predetermined number of days (for example, five days) have elapsed since the water immersion detection flag was turned on by S111 and S112 (S124). The predetermined number of days may be any period as long as it is a period longer than a period from the occurrence of the submergence until it can be determined that the submergence has been sufficiently resolved, and is, for example, a period of several days to ten-odd days.

When CPU 110 determines that the temperature of the battery 12A, 12B exceeds the predetermined temperature (YES in S122), it S125 the cooling fan 13 to operate. If it is determined that the magnitude of the current indicated by the signal received from the submergence sensor 14 is less than the threshold value (YES in S123), or if it is determined that a predetermined number of days have elapsed since the submergence detection flag was turned on (YES in S124), CPU 110 performs control to activate the cooling-fan 13 (S125). Then, CPU 110 switches the abnormality determination in progress flag indicating that the abnormality of the cooling-fan 13 is being determined to the ON state (S126), and switches the submergence detection flag to the OFF state (S127).

After S127, or when it is determined that the predetermined number of days has not elapsed since the water immersion detection flag is turned on (NO in S124), CPU 110 determines whether or not the abnormality determination in progress flag is turned on (S131). If it is determined that the battery is in the on-state (YES in S131), CPU 110 determines whether the temperature of the battery 12A, 12B indicated by the signal from the temperature sensor 15 has decreased for a predetermined period after the cooling fan 13 is operated (S132). For example, it is determined whether or not the temperature of the battery 12A, 12B has decreased by 1° C. even after 10 minutes have elapsed after the cooling fan 13 is operated at the maximum level.

When it is determined that the temperature of the battery 12A, 12B has decreased (YES in S132), it is determined whether or not the rotation speed of the cooling fan 13 has decreased as compared with the rotation speed at the normal time (S133). When it is determined that the temperature of the battery 12A, 12B has not decreased for a predetermined period (NO in S132) or when it is determined that the rotational speed of the cooling fan 13 has decreased (YES in S133), CPU 110 switches the cooling abnormality determination flag indicating that the abnormality of the cooling fan 13 has been determined to be ON-state (S134). In addition, CPU 110 switches the abnormality determination in progress flag to the off-state (S135). CPU 110 then controls HMI 200 to initiate a notification to the user indicating that the cooling-fan 13 is abnormal (S136).

When it is determined that the abnormality determination in progress flag is not in the ON state (NO in S131) or when it is determined that the rotational speed of the cooling fan 13 is not reduced (NO in S133), CPU 110 determines whether or not the cooling abnormality determination flag is in the ON state (S141). Alternatively, after S136, CPU 110 determines whether or not the cooling-abnormality determination flag is in the ON-state (S141). When it is determined that the state is the ON state (YES in S141), it is determined whether or not an operation for resetting the abnormality notification is detected by HMI 200 (S142). When it is determined that an operation for resetting the abnormality notification is detected (YES in S142), CPU 110 controls HMI 200 to terminate the notification indicating that the cooling-fan 13 to the user is abnormal (S143). In addition, CPU 110 switches the cooling-abnormality determination flag to the off-state (S144).

When it is determined that the cooling abnormality determination flag is not in the ON state (NO in S141), or when it is determined that the operation of resetting the abnormality notification is not detected (NO in S142), CPU 110 returns the processing to be executed to the processing higher than the caller of the cooling abnormality detection processing. Alternatively, after S144, CPU 110 returns the processing to be executed to the processing of the upper level of the caller of the cooling-abnormality detection processing.

### Modifications

In the above-described embodiment, the vehicles 10 are BEV. However, the present disclosure is not limited thereto, and the vehicle 10 may be another type of vehicle as long as the vehicle can travel using the electric power of the battery 12A, 12B. For example, the vehicles 10 may be hybrid electric vehicle (HEV: Hybrid Electric Vehicle), plug-in hybrid electric vehicle (PHEV: Plug-in Hybrid Electric Vehicle), or fuel cell electric vehicle (FCEV: Fuel Cell Electric Vehicle).

In the above-described embodiment, as shown in S132 of FIG. 2, the predetermined condition indicating that the cooling fan 13 is not functioning normally is a condition that there is no decrease in the temperature of the battery 12A, 12B for a predetermined period after the cooling fan 13 is operated, or a condition that the rotational speed of the cooling fan 13 is decreased as compared with the rotational speed at the normal time. However, the present disclosure is not limited thereto, and the predetermined condition may be, for example, a condition that the pressure loss in the flow path 16 of the outside air sucked by the cooling fan 13 is determined to be larger than the reference value by the method described in JP 2015-049999 A. If the pressure loss is greater than the reference value, the flow path 16 may be clogged with foreign matter such as soil or muddy.

In the above-described embodiment, as illustrated in FIG. 1, the cooling device for cooling the battery 12A, 12B is the cooling fan 13. However, the cooling device is not limited thereto, and may be another type of device, for example, a device such as an air conditioner that circulates cooled air using a refrigerant to cool the battery 12A, 12B.

In the above-described embodiment, the battery 12A, 12B is mounted on the vehicles 10. However, the present disclosure is not limited thereto, and the battery 12A, 12B may be mounted on a vehicle other than the vehicle 10 such as the passenger car illustrated in FIG. 1. Such vehicles include, for example, motorcycles, motorized bicycles, bicycles, electric kickboards, electrified vehicle chairs, senior cars, railroad vehicles, and industrial vehicles (such as forklifts). In addition, the battery 12A, 12B may be mounted on a machine different from the vehicle 10, for example, a production machine (including a construction machine, a robot, and the like), a business machine, an electric machine, an information-communication machine, a transportation machine (including not only a vehicle but also a ship, an airplane, and the like), a general-purpose machine, and the like. Further, the battery 12A, 12B may be mounted on a stationary battery device (stationary storage battery). Specifically, the stationary battery device may include a battery 12A, 12B, a cooling fan 13, a submergence sensor 14, and a control device such as an ECU 100 including a processor.

The above-described embodiment can be regarded as a disclosure of an abnormality determination system including a battery 12A, 12B, a cooling fan 13, a submergence sensor 14, and an ECU 100 as illustrated in FIG. 1, or a vehicle 10 including such an abnormality determination system. Further, the above-described embodiment can be regarded as the disclosure of the abnormality determination system or the abnormality determination method or the abnormality determination program executed by the vehicle 10 as illustrated in FIG. 2.

### SUMMARY

As illustrated in FIG. 1, the abnormality determination system is a system for determining an anomaly in a battery 12A, 12B, and includes a battery 12A, 12B, a cooling fan 13 for cooling the battery 12A, 12B, a submergence sensor 14 for detecting submergence of water in a part where the cooling fan 13 is provided, and an ECU 100 for controlling the cooling fan 13. As illustrated in FIG. 2, ECU 100 controls the cooling fan 13 to operate after the submergence of water is detected by the submergence sensor 14 (for example, after S111, S112) and after a predetermined condition for determining an anomaly of the cooling fan 13 is satisfied (for example, after the condition of S123, S124 is satisfied) (for example, a S125). When the specific condition indicating that the cooling fan 13 is not functioning normally is satisfied (for example, when it is determined that the cooling fan is NO in S132, and when it is determined that the cooling fan is YES in S133), ECU 100 determines that cooling is abnormal (for example, S134).

Thus, after the water immersion of the part where the cooling fan 13 for cooling the battery 12A, 12B is provided is detected, and after the condition for determining the abnormality of the cooling fan 13 is satisfied, the cooling fan 13 is activated, and when the condition indicating that the cooling fan 13 is not functioning normally is satisfied, it is determined that the cooling abnormality is present. As a result, the abnormality of the cooling fan 13 can be appropriately determined.

As illustrated in FIG. 2, the predetermined condition may be a condition (for example, a condition of S123) that the submergence is not detected by the submergence sensor 14. Alternatively, the predetermined condition may be a condition (for example, a condition of a S124) that a predetermined period has elapsed after the submergence of water is detected by the submergence sensor 14. Thus, the abnormality of the cooling fan 13 can be determined at an appropriate timing.

As illustrated in FIG. 2, the specific condition may be a condition (for example, a condition of S132) that the temperature of the battery 12A, 12B does not decrease as compared with a condition prior to the operation of the cooling fan 13 after the operation of the cooling fan 13. Alternatively, the specific condition may be a condition (for example, a condition of S133) that the rotation speed of the fan of the cooling fan 13 is lower than the rotation speed at the normal time. This makes it possible to determine the abnormality of the cooling fan 13 based on an appropriate criterion.

As shown in FIG. 2, ECU 100 may control the cooling fan 13 to operate (for example, S125) when the temperature of the battery exceeds the predetermined temperature (for example, when the temperature is YES in S122) even when the predetermined condition is not satisfied after the submergence of water is detected by the submergence sensor 14.

Thus, even when the condition for determining the abnormality of the cooling fan 13 is not satisfied, the cooling fan 13 can be operated when the temperature of the battery 12A, 12B is increased and the cooling fan 13 is operable.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. An abnormality determination system configured to determine an abnormality of a battery, the abnormality determination system comprising:
the battery;
a cooling device configured to cool the battery;
a sensor configured to detect submergence of a portion provided with the cooling device; and
a processor configured to control the cooling device, wherein
the processor is configured to:
control the cooling device to operate after the submergence is detected by the sensor and after a predetermined condition for determination on an abnormality of the cooling device is satisfied; and
determine that cooling is abnormal when a specific condition indicating that the cooling device is not functioning normally is satisfied.

2. The abnormality determination system according to claim 1, wherein the predetermined condition is a condition that the submergence is not detected by the sensor, or a condition that a predetermined period has elapsed after the submergence is detected by the sensor.

3. The abnormality determination system according to claim 1, wherein the specific condition is a condition that a temperature of the battery does not decrease after the cooling device is operated as compared to a timing before the cooling device is operated, or a condition that a rotation speed of a fan of the cooling device decreases as compared to a normal rotation speed.

4. The abnormality determination system according to claim 1, wherein the processor is configured to control the cooling device to operate when the predetermined condition is not satisfied after the submergence is detected by the sensor, and a temperature of the battery exceeds a predetermined temperature.

5. An abnormality determination method for determining an abnormality of a battery device,
the battery device including:
a battery;
a cooling device configured to cool the battery;
a sensor configured to detect submergence of a portion provided with the battery and the cooling device; and
a processor configured to control the cooling device,
the abnormality determination method comprising causing the processor to:
control the cooling device to operate after the submergence is detected by the sensor and after a predetermined condition for determination on an abnormality of the cooling device is satisfied; and
determine that cooling is abnormal when a specific condition indicating that the cooling device is not functioning normally is satisfied.
